(19) United States
(12) Patent Application Publication
(10) Pub. No.: US 2012/0306588 A1
(43) Pub. Date: Dec. 6, 2012

(54) FLUX GUIDING STRUCTURE

(75) Inventors: Malcolm Duncan Mcculloch, Oxford (GB); Christopher John Stevens, Oxford (GB)

(73) Assignee: ISIS INNOVATION LTD, Oxford (GB)

(21) Appl. No.: 13/514,535

(22) PCT Filed: Dec. 7, 2010
(86) PCT No.: PCT/GB10/52039

§ 371 Date: Aug. 23, 2012

(30) Foreign Application Priority Data
Dec. 7, 2009 (GB) GB0921400.8

(51) Int. Cl. H01P 1/10

(52) U.S. Cl. 333/101

(57) ABSTRACT

Embodiments of the present invention provide a structure comprising: a flux guide comprising a plurality of resonant circuit elements (110, 120, 310F) each element comprising an electrically conductive loop portion (112, 122), opposed ends of the loop portion (112, 122) being coupled to one another through a capacitive element (114, 124), adjacent resonant elements of the flux guide (115, 315) being arranged to be magneto-inductively coupled to one another thereby to allow a magneto-inductive (MI) wave to be supported by the guide (115, 315), wherein at least one of the resonant elements (1205) is switchable between a first condition in which the element is arranged to support propagation of an MI wave along the waveguide and a second condition in which the element is arranged to prevent propagation of an MI wave along the waveguide.

### FIELD OF THE INVENTION

The present invention relates to flux guiding structures. In particular but not exclusively the invention relates to transformer structures comprising a metamaterial.

### BACKGROUND OF THE INVENTION

It is known to use a metamaterial structure in the form of an array of magneto-inductively coupled resonator devices as a flux guide in a magnetic resonance imaging (MRI) system. Use of the metamaterial structure has the advantage that a requirement to use iron as a flux guide in the MRI system may be eliminated.

### STATEMENT OF THE INVENTION

In a first aspect of the invention there is provided a structure comprising:
a flux guide comprising a plurality of resonant circuit elements each element comprising an electrically conductive loop portion, opposed ends of the loop portion being coupled to one another through a capacitive element, adjacent resonant elements of the flux guide being arranged to be magneto-inductively coupled to one another thereby to allow a magneto-inductive (MI) wave to be supported by the guide,
wherein at least one of the resonant elements is switchable between a first condition in which the element is arranged to support propagation of an MI wave along the waveguide and a second condition in which the element is arranged to prevent propagation of an MI wave along the waveguide.

Embodiments of the invention enable a variety of devices to be provided including transformers and motors employing metamaterials structures. This is because metamaterials structures may be arranged to exhibit ferromagnetic behaviour. Metamaterials exhibiting ferromagnetic behaviour may be fabricated without requiring the presence of iron or other heavy materials. Thus ferromagnetic metamaterial structures may be fabricated having a weight much lower than a corresponding iron-containing structure.

Preferably the flux guide comprises a substantially closed loop, the structure being provided with input means for inducing an MI wave in the guide.

The input means may comprise a winding having at least one turn.

By winding is meant that a conductor is wound around at least a portion of the flux guide. The conductor may be wound by half a turn (substantially 180°) or more than half a turn, e.g. one or more turns.

Preferably the structure further comprises output means for inducing a flow of current in a conductor by means of an MI wave supported by the guide.

The output means may comprise a winding having at least one turn.

Such a structure has the advantage that a transformer structure may be provided without a requirement to employ iron or iron-based materials.

The structure may comprise first and second output means for inducing a flow of current in first and second conductors, respectively, by means of an MI wave supported by the guide.

The flux guide may be operable to prevent a current from being induced in the first conductor by means of a first switchable resonant element.

Alternatively or in addition the flux guide may be operable to prevent a current from being induced in the second conductor by means of a second switchable resonant element.

Optionally the flux guide may comprise first and second substantially closed flux paths, the first output means being provided in the first path and not the second path, the second output means being provided in the second path and not the first path.

Preferably the at least one of the resonant elements is switchable by means of a switch provided in series with the loop portion of the resonant circuit element.

The structure may comprise a rotor member, the rotor member having at least one resonant circuit element provided thereon, the rotor member being rotatable about a transverse axis whereby the at least one resonant circuit element may be caused to pass between a pair of adjacent resonant circuit elements of the flux guide, the structure being operable to induce a MI wave in the flux guide thereby to cause rotation of the rotor member.

The structure may be operable whereby the resonant circuit element of the rotor may be magneto-inductively coupled to at least one of the resonant circuit elements of said flux guide, said coupling being arranged to create a force between the resonant circuit element of the rotor and said at least resonant circuit elements of the flux guide in a direction to cause rotation of the rotor about the transverse axis.

The rotor may be provided with a ring of resonant circuit elements disposed about the transverse axis, respective resonant circuit elements of the ring being disposed substantially equal distances from said transverse axis.

In a second aspect of the invention there is provided a structure comprising: a flux guide comprising a plurality of resonant circuit elements each element comprising an electrically conductive loop portion, opposed ends of the loop portion being coupled to one another through a capacitive element, adjacent resonant elements of the flux guide being magneto-inductively coupled to one another, and at least a first winding member, the first winding member being magneto-inductively coupled to a first resonant circuit element of the flux guide, the first winding member being arranged to allow a magneto-inductive wave to be established in the flux guide when an alternating current flows in the first winding, the alternating current being caused to flow at a frequency sufficiently close to and below a resonant frequency of the resonant circuit elements of the flux guide.

By winding is meant that a conductor is wound around at least a portion of the flux guide.

The conductor may be wound by half a turn (substantially 180°) or more than half a turn, e.g. one or more turns.

Preferably the structure comprises a second winding member, the second winding being magneto-inductively coupled to a second resonant circuit element of the flux guide.

The first winding may be arranged to allow an alternating current flowing therein to induce a corresponding alternating current in the second winding by means of the magneto-inductive coupling between adjacent resonant circuit elements of the flux guide.

Such a structure has the advantage that a transformer structure may be provided without a requirement to employ iron or iron-based materials.

Preferably a resonant circuit element of the flux guide comprises a switch member, the switch member being arranged to prevent an alternating current flowing in the first winding from inducing a corresponding alternating current in the second winding.

Preferably the flux guide comprises a plurality of flux guide portions connected in parallel with one another, each portion having a winding provided therearound.

A resonant circuit element of the flux guide preferably comprises a switch member, the switch member being arranged to prevent an alternating current flowing in the first winding from inducing a corresponding alternating current in the second winding.

Preferably the switch member is provided at a location of the flux guide whereby a flow of flux along a flux guide portion may be substantially prevented.

The switch member may be provided in series with the loop portion of the resonant circuit element and in parallel with a capacitive element of the resonant circuit.

The structure may further comprise a rotor member, the rotor member having at least one resonant circuit element provided thereon, the rotor member being arranged to rotate about a transverse axis whereby the at least one resonant circuit element is caused to pass between a pair of adjacent resonant circuit elements of the flux guide.

The structure is preferably arranged whereby the resonant circuit element of the rotor may be magneto-inductively coupled to at least one of the resonant circuit elements of said pair, said coupling being arranged to create a force between the resonant circuit element of the rotor and at least one of the resonant circuit elements of said pair in a direction to cause rotation of the rotor about the transverse axis.

The rotor may be provided with a ring of resonant circuit elements disposed about the transverse axis, respective resonant circuit elements of the ring being disposed substantially equal distances from said transverse axis.

In a further aspect of the present invention there is provided a transformer structure comprising: a flux guide comprising a plurality of resonant circuit elements each element comprising an electrically conductive loop portion, opposed ends of the loop portion of each resonant circuit element being coupled to one another through a capacitive element, adjacent resonant elements of the flux guide being magneto-inductively coupled to one another; and first and second windings, the first winding being magnetoinductively coupled to a first resonant circuit element of the flux guide, the second winding being magnetoinductively coupled to a second resonant circuit element of the flux guide, the first winding being arranged to allow an alternating current flowing therein to induce a corresponding alternating current in the second winding by means of the magneto-inductive coupling between adjacent resonant circuit elements of the flux guide.

### BRIEF DESCRIPTION OF THE DRAWINGS

Embodiments of the invention will now be described with reference to the accompanying figures in which:

FIG. 1 shows (a) a switchable transformer according to an embodiment of the invention and (b) a schematic circuit diagram of the transformer shown in (a);

FIG. 2 (a), (b) show resonant circuit elements employed in embodiments of the invention;

FIG. 3 shows an actuator in the form of a motor according to an embodiment of the invention;

FIG. 4 shows (a), (b) plots of magnetic permeability of a resonant circuit element as a function of frequency and (c) a resonant circuit element having a capacitance switchable between two different respective values; and

FIG. 5 shows a resonant circuit element suitable for use in some embodiments of the invention.

### DETAILED DESCRIPTION

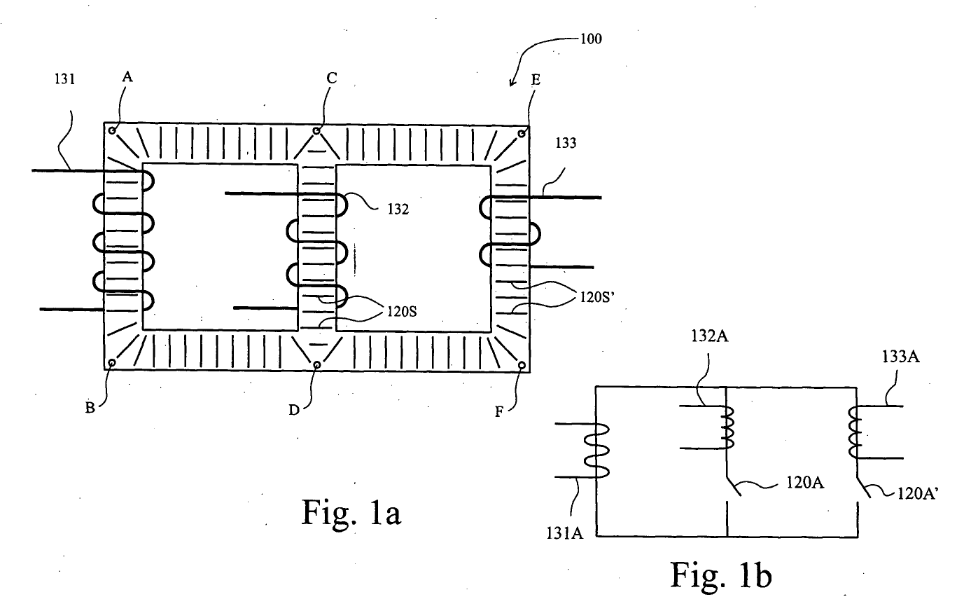

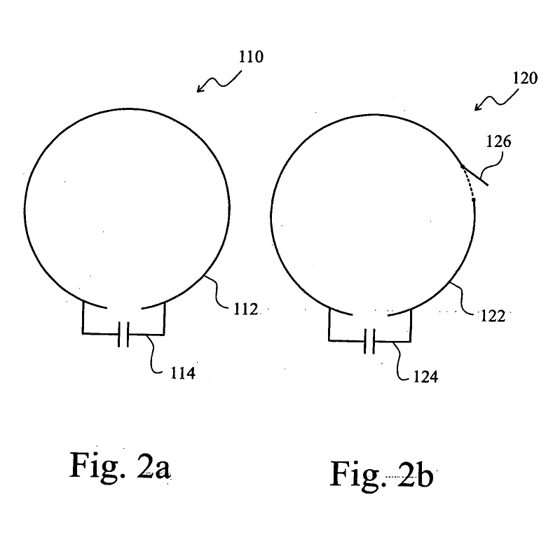

In one embodiment of the invention a switchable transformer structure 100 is provided substantially as shown in FIG. 1. The structure 100 is formed from a plurality of resonant circuit elements 110. As shown in FIG. 2, each of the elements 110 has a loop portion 112 having a resistance and an inductance, and in addition a capacitive portion 114 (see FIG. 2). In the structure of FIG. 1 the circuit elements 110 are arranged to be coupled to one another to form a flux guide 115 substantially in the form of a figure of 8.

The resonant circuit elements 110 are coupled to one another along an axial direction, an axial direction being a direction normal to a plane of the loop portions 112. It is to be understood that coupling between adjacent loops may have a planar component in addition to an axial component, for example at bends in the flux guide 115 indicated A, B, C, D, E and F in FIG. 1(a). By planar component is meant a component normal to an axial direction in a plane of the loop portion 112 of an element 110.

Three windings are provided around respective portions of the flux guide 115. A first winding 131 located between positions A and B; a second winding 132 located between positions C and D and a third winding 133 located between positions E and F.

The structure is arranged whereby an alternating current may be passed through one of the windings (such as the first winding 131) at a frequency equal to or close to a resonant frequency of the resonant circuits 110 of the flux guide 115. This current causes a magneto-inductive wave to be created in the flux guide 115 that may in turn cause a corresponding current to be induced in one or both of the other windings (i.e. the second and/or third winding 132, 133).

It is to be understood that values of resistance, inductance and capacitance (R,L,C respectively) of a circuit element 110 may be selected to provide a resonant frequency within a frequency range of interest. Resonant frequencies may be arranged to be any suitable frequency from around 10 Hz to around 500 kHz or more.

In some embodiments, one or more resonant elements 120, 120′ of the flux guide 115 are provided with a switch element 126 such as that shown in FIG. 2(b) arranged to allow the one or more resonant elements 120, 120′ to be prevented from resonating when the switch element 126 is in an open configuration. The loop portion 122 and capacitive portion 124 of the switch element 120 are arranged to have substantially the same electrical and magnetic characteristics as those of non-switchable circuit elements 110.

In the transformer structure of FIG. 1(a) one of the resonant circuit elements 120 between positions C and D is provided with a switch element as is one of the circuit elements 120S′ between positions E and F.

It is to be understood that with the switch elements 126 of each of the circuit elements 120S, 120S′ in a closed configuration the first winding 131 may induce a current in both of the second and third windings 132, 133. However, if the switch element 126 of resonant circuit element 120S is in the open configuration a current can no longer be induced in the second winding 132.

Similarly, if the switch element of resonant circuit elements 120S′ is in the open configuration a current can no longer be induced in the third winding 133.

Embodiments of the invention therefore provide a convenient means by which a flux switch may be provided in a transformer structure. Furthermore, embodiments of the invention have the advantage that a weight of a transformer structure may be reduced since a requirement to employ heavy ferromagnetic materials such as iron or iron-based materials may be eliminated.

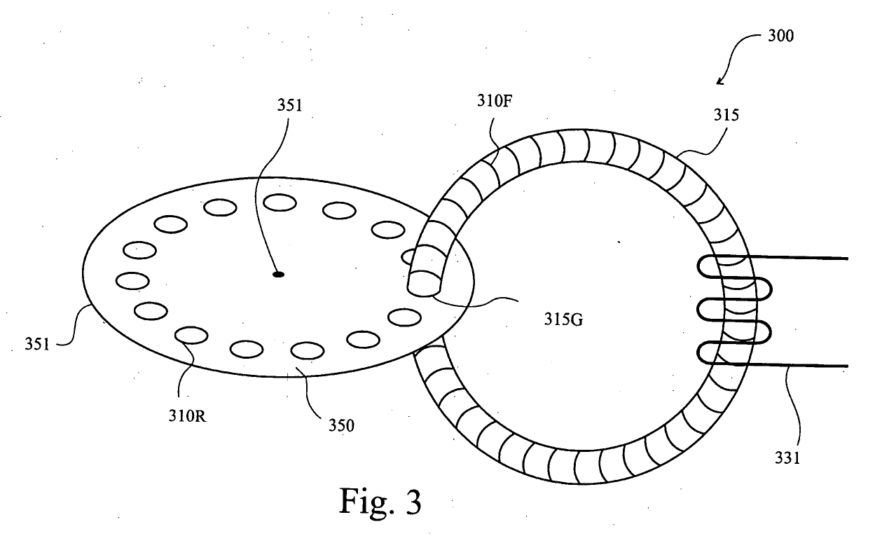

FIG. 3 shows an embodiment of the invention in the form of a rotational actuator device 300. The device 300 has a flux guide 315 comprising a plurality of resonant circuit elements 310F arranged to be coupled to one another in a substantially axial manner. The flux guide is arranged to define a substantially closed path.

A winding 331 is provided around a portion of a length of the flux guide 315. The winding 331 is arranged to be magneto-inductively coupled to one or more resonant circuit elements 310F of the flux guide 315.

The device 300 also has a rotor portion 350 in the form of a substantially planar, substantially disc-shaped member 350 arranged to rotate about an axis 351. The rotor portion 350 has a series of planar-coupled resonant elements 310R provided around a circumference thereof. Other arrangements are also useful, for example an arrangement in which the resonant elements 310R are provided radially inward of a circumferential rim 351 of the rotor portion 350.

The flux guide 315 is arranged whereby a gap 315G is provided between a pair of axially adjacent resonant circuit elements 310F of the flux guide 315. The rotor portion 350 is arranged to protrude into this gap 315G such that rotation of the rotor portion 350 results in the resonant circuit elements of the rotor 310R passing through the gap 315G.

As the resonant circuit elements 310R pass through the gap 315G they become momentarily substantially co-axial with the pair of adjacent resonant circuit elements 310F.

It is to be understood that a magneto-inductive wave passing along the flux guide 315 may be arranged to subject a resonant circuit element 310R of the rotor portion 350 passing through the gap 315G firstly to an attractive force, drawing the resonant circuit element 310R towards the flux guide 315 to a location in which it is substantially coaxial with the pair of adjacent resonant circuit elements 310F, and subsequently to a repulsive force, repelling the resonant circuit element 310R away from the flux guide 315.

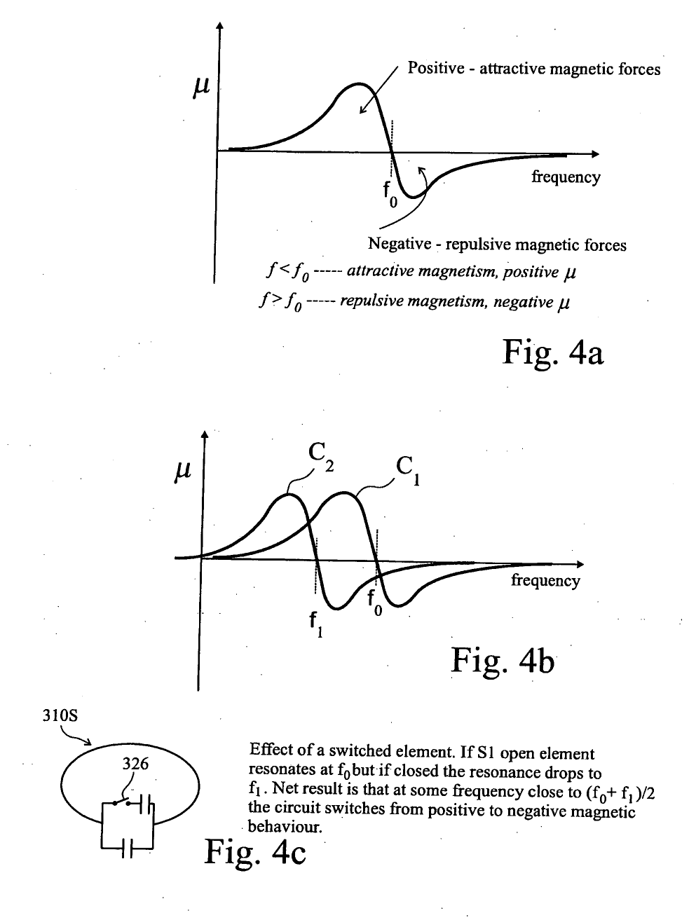

FIG. 4(a) shows a magnetic permeability μ of a resonant circuit element as a function of a frequency at which the element is excited. It can be seen that the element exhibits a positive value of μ when excited at a frequency f below a resonant frequency f₀ of the element and a negative value of μ when excited at a frequency above the resonant frequency. Thus, with f<f₀ an attractive magnetic force may be generated between adjacent circuit elements 310. Similarly, with f>f₀ a repulsive magnetic force may be generated between adjacent circuit elements 310

It is to be understood that if a capacitance C of the capacitive portion of a resonant element is changed, the resonant frequency of the element may be changed and therefore the value of μ.

FIG. 4(b) shows a plot of μ as a function of f for a resonant circuit having a capacitance C of two respective different values, C₁ and C₂.

It can be seen from the plot that with a value of capacitance of C₁ the circuit has a resonant frequency f₀ whilst with a value of capacitance of C2 (where C₂>C₁) the circuit has a resonant frequency f₁<fₒ.

FIG. 4(c) shows a resonant circuit 310S having a capacitive portion arranged to be switchable between a value of C₁ (with switch 326 open) and C₂ (with switch 326 closed). Thus if the circuit is caused to resonate at an operational frequency fₒₚ of around (f₀+f₁)/2, for example by means of an MI wave of this frequency the circuit may be switched from positive to negative magnetic behaviour as the switch is moved from an open condition to a closed condition, and vice versa. For example, if switch 326 is open the circuit 310S may resonate at a frequency f₀, and if the switch is closed the resonance may fall to a frequency f₁. The net result may be that at a frequency close to (f₀+f₁)/2 the circuit may switch from positive to negative magnetic behaviour.

Thus, in use, a flux guide 315 formed from resonant circuit elements 310S is provided and an MI wave of frequency fₒₚ is established in the flux guide. The switches 326 of the elements 310S of the guide 315 are then switched between open and closed conditions in synchrony with one another thereby to establish an alternately attractive and repulsive magnetic field in the gap 315G. The structure is thereby operable to cause the rotor portion 350 to rotate as circuits 310R of the rotor portion are sequentially attracted to and repelled by the magnetic field in the gap 315G.

It is to be understood that a plurality of flux guides 315 may be employed in a single device in order to increase a magnitude of a force applied to the rotor portion 350 to cause rotation thereof. Flux guides 315 may be arranged circumferentially and/or radially about the rotor portion 350.

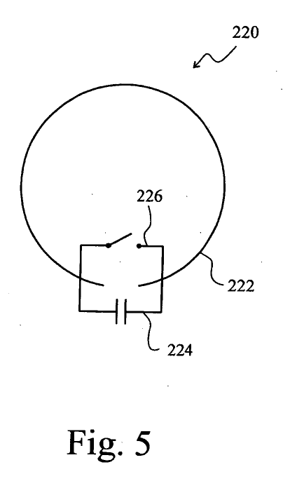

In some embodiments of the invention, a resonant circuit element 220 is provided in which a switch element 226 is connected in parallel with the capacitive element 224 as shown in FIG. 5. It is to be understood that by closing the switch element 226 a circuit element in the form of a loop may be provided.

It is to be understood that according to Lenz's law, a simple closed loop of wire exposed to an ac magnetic field will generate an opposing magnetic field that partially cancels the applied field. This phenomenon is directly equivalent to the behaviour of a diamagnetic material. Thus, the resonant circuit element 220 of FIG. 5 will therefore, with the switch 226 in a closed configuration, exhibit a diamagnetic property.

If the simple closed loop of wire is replaced by a loop in which a capacitive element is connected in parallel with the loop a resonant circuit is created (as in the case of the circuit elements of FIG. 2).

This circuit with exhibit a ferromagnetic property. This is because close to the resonant frequency of the resonant circuit, below the resonant frequency, a positive phase relationship exists between induced electromotive force and current flow in the loop. Thus, a first resonant circuit will induce a flow of current in a second, adjacent resonant circuit in an opposite direction to that of the first resonant circuit. Consequently the respective currents each produce magnetic flux lines that are directed in opposite directions relative to one another. This phenomenon is directly equivalent to the behaviour of a ferromagnetic material. Thus, the resonant circuit elements 110, 120 of FIG. 2 will, with the switch 126 of the element 120 in a closed configuration, exhibit a ferromagnetic property.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A structure comprising:
a flux guide comprising a plurality of resonant circuit elements (110, 120, 310F) each element comprising an electrically conductive loop portion (112, 122), opposed ends of the loop portion (112, 122) being coupled to one another through a capacitive element (114, 124), adjacent resonant elements of the flux guide (115, 315) being arranged to be magneto-inductively coupled to one another thereby to allow a magneto-inductive (MI) wave to be supported by the guide (115, 315),
wherein at least one of the resonant elements (1205) is switchable between a first condition in which the element is arranged to support propagation of an MI wave along the waveguide and a second condition in which the element is arranged to prevent propagation of an MI wave along the waveguide.

2. A structure as claimed in claim 1 wherein the flux guide (115, 315) comprises a substantially closed flux path, the structure being provided with input means (131, 331) for inducing an MI wave in the guide.

3. A structure as claimed in claim 2 wherein the input means comprises a winding (131, 331) having at least one turn.

4. A structure as claimed in claim 2 or 3 wherein the structure further comprises output means (132, 133) for inducing a flow of current in a conductor by means of an MI wave supported by the guide (115).

5. A structure as claimed in claim 4 wherein the output means comprises a winding (132, 133) having at least one turn.

6. A structure as claimed in claim 4 or claim 5 wherein the structure comprises first (132) and second (133) output means for inducing a flow of current in first and second conductors, respectively, by means of an MI wave supported by the guide.

7. A structure as claimed in claim 6 wherein the flux guide is operable to prevent a current from being induced in the first conductor (132) by means of a first switchable resonant element (1205).

8. A structure as claimed in claim 6 or claim 7 wherein the flux guide (115) is operable to prevent a current from being induced in the second conductor (133) by means of a second switchable resonant element (1205′).

9. A structure as claimed in claim 7 or claim 8 wherein the flux guide (115) comprises first and second substantially closed flux paths, the first output means (132) being provided in the first path and not the second path, the second output means (132) being provided in the second path and not the first path.

10. A structure as claimed in any preceding claim wherein the at least one of the resonant elements (1205) is switchable by means of a switch (126) provided in series with the loop portion (122) of the resonant circuit element.

11. A structure as claimed in any preceding claim comprising a rotor member (351), the rotor member (351) having at least one resonant circuit element 310R provided thereon, the rotor member (351) being rotatable about a transverse axis whereby the at least one resonant circuit element 310R may be caused to pass between a pair of adjacent resonant circuit elements of the flux guide (315), the structure being operable to induce a MI wave in the flux guide (315) thereby to cause rotation of the rotor member (351).

12. A structure as claimed in claim 11 operable whereby the resonant circuit element (310R) of the rotor may be magneto-inductively coupled to at least one of the resonant circuit elements of said flux guide (310F), said coupling being arranged to create a force between the resonant circuit element (310F) of the rotor (351) and said at least resonant circuit elements of the flux guide (315) in a direction to cause rotation of the rotor (351) about the transverse axis.

13. A structure as claimed in claim 11 or claim 12 wherein the rotor (351) is provided with a ring of resonant circuit elements (310R) disposed about the transverse axis, respective resonant circuit elements of the ring being disposed substantially equal distances from said transverse axis.

14. A structure comprising:
a flux guide (115, 315) comprising a plurality of resonant circuit elements (110, 120) each element comprising an electrically conductive loop portion (112, 122), opposed ends of the loop portion (112, 122) being coupled to one another through a capacitive element (114, 124), adjacent resonant elements (110, 120) of the flux guide (115, 315) being magneto-inductively coupled to one another; and
at least a first winding member (131, 331),
the first winding member (131, 331) being magneto-inductively coupled to a first resonant circuit element of the flux guide,
the first winding member (131, 331) being arranged to allow a magneto-inductive wave to be established in the flux guide (115, 315) when an alternating current flows in the first winding (131, 331), the alternating current being caused to flow at a frequency sufficiently close to and below a resonant frequency of the resonant circuit elements of the flux guide (115, 315).

15. A structure as claimed in claim 14 further comprising a second winding member (132, 133), the second winding (132, 133) being magneto-inductively coupled to a second resonant circuit element of the flux guide (115, 315).

16. A structure as claimed in claim 15 wherein the first winding (131) is arranged to allow an alternating current flowing therein to induce a corresponding alternating current in the second winding (132, 133) by means of the magnetoinductive coupling between adjacent resonant circuit elements of the flux guide (115).

17. A structure as claimed in any one of claims 14 to 16 wherein the flux guide (115) comprises a plurality of flux guide portions connected in parallel with one another, each portion having a winding provided therearound.

18. A structure as claimed in any one of claims 14 to 17 wherein a resonant circuit element (120S) of the flux guide comprises a switch member (126), the switch member (126) being arranged to prevent an alternating current flowing in the first winding (131) from inducing a corresponding alternating current in the second winding (132, 133).

19. A structure as claimed in claim 17 or claim 18 wherein the switch member (126) is provided at a location of the flux guide whereby a flow of flux along a flux guide portion may be substantially prevented.

20. A structure as claimed in claim 18 or claim 19 depending through claim 17 wherein the switch member (126) is provided in series with the loop portion (122) of the resonant circuit element and in parallel with a capacitive element of the resonant circuit.

21. A structure as claimed in any one of claims 14 to 20 comprising a rotor member (351), the rotor member having at least one resonant circuit element (310R) provided thereon, the rotor member (351) rotatable about a transverse axis whereby the at least one resonant circuit element (310R) may be caused to pass between a pair of adjacent resonant circuit elements (310F) of the flux guide (310).

22. A structure as claimed in claim 21 wherein the resonant circuit element (310R) of the rotor may be magneto-inductively coupled to at least one of the resonant circuit elements of said pair of adjacent resonant elements, said coupling being arranged to create a force between the resonant circuit element of the rotor (351) and at least one of the resonant circuit elements of said pair in a direction to cause rotation of the rotor (351) about the transverse axis.

23. A structure as claimed in claim 21 or claim 22 wherein the rotor (351) is provided with a ring of resonant circuit elements (310R) disposed about the transverse axis, respective resonant circuit elements of the ring being disposed substantially equal distances from said transverse axis.

24. A transformer structure comprising:
a flux guide (115) comprising a plurality of resonant circuit elements (110, 120) each element comprising an electrically conductive loop portion (112, 122), opposed ends of the loop portion (112, 122) of each resonant circuit element (110, 120) being coupled to one another through a capacitive element, adjacent resonant elements of the flux (115) guide being magneto-inductively coupled to one another; and
first and second windings (131, 132, 133),
the first winding (131) being magnetoinductively coupled to a first resonant circuit element of the flux guide (115),
the second winding (132, 132) being magnetoinductively coupled to a second resonant circuit element of the flux guide (115),
the first winding (131) being arranged to allow an alternating current flowing therein to induce a corresponding alternating current in the second winding (132, 133) by means of the magneto-inductive coupling between adjacent resonant circuit elements of the flux guide (115).
